(19) United States
(12) Patent Application Publication
(10) Pub. No.: US 2014/0210695 A1
(43) Pub. Date: Jul. 31, 2014

(54) SECURING INFORMATION

(71) Applicant: HEWLETT-PACKARD DEVELOPMENT COMPANY, Fort Collins, CO (US)

(72) Inventor: Kun-Shan Lin, Taipei (TW)

(73) Assignee: HEWLETT-PACKARD DEVELOPMENT COMPANY, Fort Collins, CO (US)

(21) Appl. No.: 13/754,827

(22) Filed: Jan. 30, 2013

(51) Int. Cl. G09G 3/00

(52) U.S. Cl. CPC G09G 3/00
USPC 345/32

(57) ABSTRACT

A method for securing information displayed on an electronic device is provided in accordance with an aspect of the present disclosure. The electronic device obtains second information corresponding to first information. The first information has a plurality of original frames, and the second information has a plurality of pairs of frames each pair comprising an original frame included in the first information and a corresponding compensated frame. The second information is displayed on a screen of the electronic device. A filter associated with the electronic device can remove the compensated frames included in the second information.

### BACKGROUND

As the ubiquitous network society fast becomes a reality, information can be readily accessed in nearly any setting, and the demand for personal information terminals, such as notebook PCs, mobile phones, and PDAs, is growing rapidly.

Sometimes a user needs to read or type private information in public place by handset or portable electrical devices like laptop or smart phone. It might be concerned that the information in the monitor would be seen by others. For example, a user may prefer it if a stranger sitting next to him or her on a train can not read a text message the user has just received.

Sharp corporation has launched Veil View triple angled-display LCD technology in 2006. Sharp engineers have managed to control the angle of visibility using a parallax barrier used in 3D displays. That is, an authorized user within an effective range of view angle can see the information on the screen while other person outside the effective range cannot see the information. In this way, snooping can be prevented. However, the other person still can see the information from the screen if they adjust the view angle toward the angle of a center viewer which may probably be the authorized user.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 is a flow diagram illustrating a process for securing information display according to an example of the present disclosure.

FIG. 2A illustrates a first data stream according to an example of the present disclosure.

FIG. 2B illustrates a second data stream corresponding to the first data stream shown in FIG. 2A according to an example of the present disclosure.

FIG. 3 is a flow diagram illustrating a process for securing information display according to an example of the present disclosure.

FIG. 4 is a flow diagram illustrating a process for securing information display according to an example of the present disclosure.

FIG. 5 is a flow diagram illustrating a process for securing information display according to an example of the present disclosure.

FIG. 6A is a graph illustrating a frame with type A according to an example of the present disclosure.

FIG. 6B is a graph illustrating a frame with type B according to an example of the present disclosure.

FIG. 6C is a graph illustrating an overlap of the frame with type A shown in FIG. 6A and the frame with type B shown in FIG. 6B according to an example of the present disclosure.

FIG. 7 illustrates transmission of light waves passing through polarization glasses according to an example of the present disclosure.

FIG. 8 is a block diagram illustrating an electronic device according to an example of the present disclosure.

FIG. 9 illustrates an electronic device according to an example of the present disclosure.

FIG. 10 illustrates an electronic device according to an example of the present disclosure.

FIG. 11 illustrates an electronic device according to an example of the present disclosure.

### DETAILED DESCRIPTION

Reference will now be made in detail to examples, which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. Also, the figures are only illustrations of an example, in which the modules or procedures shown in the figures are not necessarily essential for implementing the present disclosure. In other instances, well-known methods, procedures, components, and circuits have not been described in detail so as not to unnecessarily obscure aspects of the examples.

With today's emphasis on safe handling of information/data, there is an increasing need to provide a method for securing information display. For example, when a user reads or types private information in public by an electronic device, there is a need to prevent information leakage. Also, there is a need to provide electronic devices like notebook PCs and mobile phones, which are frequently used to handle private information, with the capability to veil the display so that the screen content cannot be seen by other people in the immediate area looking at the screen even from the center view angle.

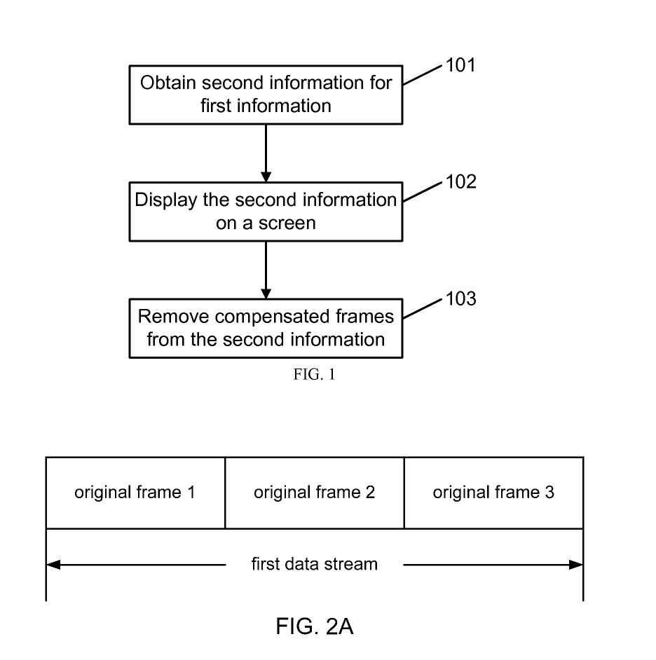

FIG. 1 is a flow diagram illustrating a process for securing the display of information provided by an electronic device according to an example of the present disclosure.

In an example, the electronic device may be a device configured to present visible information on a display to a user. The electronic device may be portable, or instead be generally stationary. For example, the electronic device can be domestic appliance such as a television (TV), or vehicle instrument such as a telematics unit (TMU), or medical equipment, or an automatic teller machine (ATM), or a computer, or a telephone, or the like. Specifically, the electronic device can be any portable electrical device, including but not limited to a handheld computer, a tablet computer, a notebook PC, a laptop, a handset, a mobile phone, a smart phone, a media player, a gaming device, a personal digital assistant (PDA), a projector, including a combination of two or more of these items.

While the process described below includes a number of operations that appear to occur in a specific order, it should be apparent that the process may include more or fewer operations, which may be executed serially or in parallel (e.g., using parallel processors or a multi-threading environment).

At block 101, second information based on first information to be veiled is obtained. In an example, the first information is discernable by naked eyes, and the second information has a special data format for restricting the first information to be peeked at. For example, the first information is private information, and the second information is encrypted information. In an example, the encrypted information is generated beforehand and prestored in the electronic device for a user to access. In another example, the encrypted information is generated temporarily according to a user's instruction.

For example, the first information may be a first data stream (also called an ordinary data stream or a normal data stream), which can be seen by naked eyes. That is, when the first data stream is displayed on the screen of the electronic device, people near the electronic device can view the first data stream without any special processing. Specifically, the first data stream includes multiple frames, e.g., original frame 1, original frame 2, original frame 3 . . . .

For each original frame in the first data stream, a compensated frame is provided. In an example, the color of an original frame is reversed to generate a corresponding compensated frame. In another example, original color of a first portion of the original frame is reversed, and the first portion of the original frame with reversed color and the other portion of the original frame with the original color are recorded to form the corresponding compensated frame. Specifically, the first portion may be partial pixels of the original frame.

Accordingly, the second information is created based on the first data stream. In an example, the second information is a second data stream including multiple pairs of frames, wherein each pair of frames includes a frame with type A and a frame with type B. The frame with type A is an original frame of the first data stream, while the frame with type B is a compensated frame of the original frame. That is, compensated frames are added into the first data stream, and each compensated frame is inserted into the first data stream right after or before its corresponding original frame to form the second data stream. Then, the second data stream has original part including the original frames representing the original information and compensated part including the compensated frames. In other words, the first data stream is encrypted to obtain the second data stream having A-B type frames. In an example, the frame with type A is a positive image while the frame with type B is a negative image. As used in the present disclosure, the second data stream refers to a data stream with A-B type frames, while the first data stream refers to a data stream with A type frames.

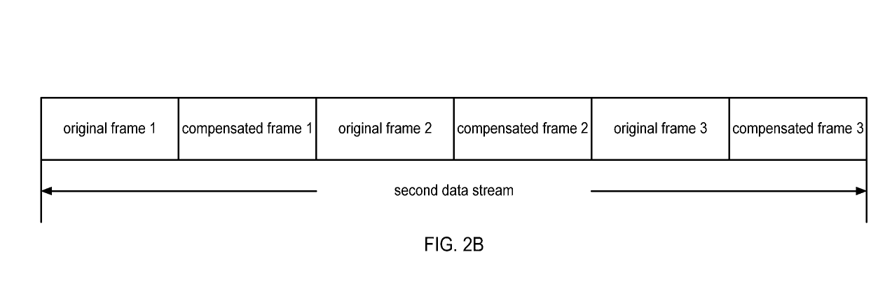

In an example, a first data stream shown in FIG. 2A includes original frame 1, original frame 2 and original frame 3. Compensated frame 1, compensated frame 2, compensated frame 3 correspond to original frame 1, original frame 2, original frame 3, respectively. Then, a second data stream shown in FIG. 2B corresponding to the first data stream may have a set of frames including original frame 1, compensated frame 1, original frame 2, compensated frame 2, original frame 3, compensated frame 3 in time sequence. In other words, original frames and compensated frames are interleaved in the second data stream.

In an example, the first data stream or second data stream can be a text file containing such as words or characters, or an image file or a video file including pictures or photos or images or graphics or video, or any combination thereof.

At block 102, a screen of the electronic device displays the second information.

Specifically, the second information is shown in the display of the electronic device according to the sequence of the frames included in the second information. Since a frame with type B is adjacent to a frame with type A in the second information, the human eyes would see a block with no meaningful information due to the A-B frames overlapping which may cause retentivity of vision (also called persistence of vision). In other words, the valid information displayed in the screen is obfuscated.

In an example, the display or screen may include any suitable type of interface or surface for the visual presentation of data, such as a photographic image. The display may include a display embedded in the electronic device or coupled to the electronic device (e.g., a removable display or a display remote from the electronic device). In an example, the display may use liquid crystal display (LCD) technology, or light emitting polymer display (LPD) technology, or digital light procession (DLP) technology, or cathode ray tube (CRT) technology, or plasma display panel (PDP) technology, or light emitting diode (LED) technology, or organic light-emitting diode (OLED) technology, or surface-conduction electron-emitter display (SED) technology, or carbon nanotube display technology, or nanocrystal display technology, or combination thereof, although other display technologies may be used in other examples.

For example, a polarization or shutter 3D LCD panel may be used as the screen of the electronic device. The 3D LCD monitor displays interleaved type A and type B frames over 24 frames per second. The human eyes would see a black or color block due to the overlapping of A-B frames which may cause retentivity of vision. In another example, the display may be a projection screen, which reflects lights emitted from one or more projectors.

At block 103, a filter matched with the electronic device removes the compensated part from the second information to enable a user with the filter to see the original part representing the first information correctly.

Specifically, the filter is a pair of glasses/specs, wherein the two lenses of the filter have the same working mode. In an example, the filter controls when lights emitted from the display are permitted to enter both the left and right eyes of the user and when the lights are blocked. In another example, the filter controls the polarization direction of the lights entering the human eyes. In another example, the filter controls the wavelength of the lights entering the human eyes. In an example, the filter can be shutter glasses or polarization glasses or wavelength multiplexed glasses. By filtering negative images from a second data stream with alternating positive and negative images, the user can see the positive images but other person would see a blank display as the positive and negative images overlap. That is, the shutter or polarization or wavelength multiplexed glasses can help to filter frames with type B or compensated frames (in this case negative images). Hence, people with the glasses can see a correct character or picture, and the naked eyes only can see a black or color brick with meaningless information due to the eye retentivity of vision.

In an example, when displaying the second information on the screen at block 102, a first polarization direction is set for light displaying the original frames, and a second polarization direction different from the first polarization direction is set for light displaying the compensated frames. Specifically, the first polarization direction is orthogonal to the second polarization direction. Accordingly, the filter is set to block the light with the second polarization direction at block 103. Light with the first polarization direction is always able to pass through the filter and enter the user's eyes.

In an example, when displaying the second information on the screen at block 102, a first wavelength is set for light displaying the original frames, and a second wavelength is set for light displaying the compensated frames. Specifically, the first wavelength is selected from the wavelength of red light, the wavelength of green light, and the wavelength of blue light, and the second wavelength different from the first wavelength is also selected from the wavelengths of red light, green light, and blue light. Accordingly, the filter is set to block the light with the second wavelength at block 103 while permitting the light with the first wavelength to enter the user's eyes.

In an example, the frames of the second information are sequentially displayed on the screen at block 102 according to a preset refresh frequency or refresh rate. In order to match with the screen, the filter is set to close at the time the compensated frames are displayed on the screen according to the refresh frequency at block 103. The filter is open at the time the original frames are displayed on the screen, thereby allowing light representing the original frames visible to the user.

Other optical characteristics, not limited to polarization direction, wavelength and refresh frequency, can be applied in the present disclosure through the cooperation of the display and the filter for filtering the compensated frames.

In view of the above, an anti-peeking display technology, which is capable of securing privacy information, is provided. The anti-peeking display technology is suitable for such as portable or handset devices or computing monitors. The anti-peeking display technology prevents or secures private information to be looked in by others from the portable or handset devices when the user is typing or reading. In other words, the technology will allow people to view email and other personal information on an electronic device such as a notebook PC and a mobile phone with peace of mind without having to worry about others in the vicinity snooping to peek at what is being displayed on the screen.

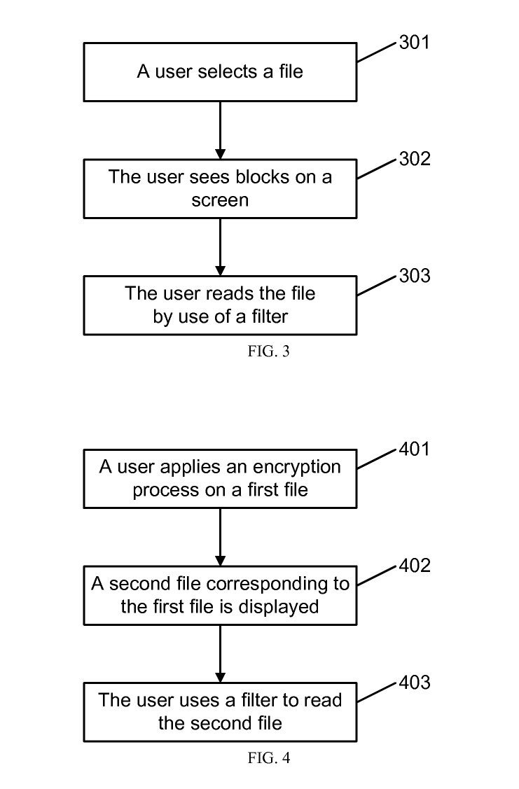

In a scenario as shown in FIG. 3, a user selects a file from the electronic device and clicks on the icon of the file to open it (block 301). The user sees blocks on the screen of the electronic device (block 302). He or she knows that the file relates to private information and may read the file by use of a filter (block 303). In an example, the file is encrypted beforehand into second information with A-B type frames, and stored in a memory of the electronic device.

In a scenario as shown in FIG. 4, when a user wants to open a first file he or she considers as confidential, the user applies an encryption process on the first file (block 401). The encryption process may turn the first file into a second file with A-B type frames and the second file is displayed on the screen (block 402). Thereafter, the user uses a filter to read the second file for securing the information (block 403).

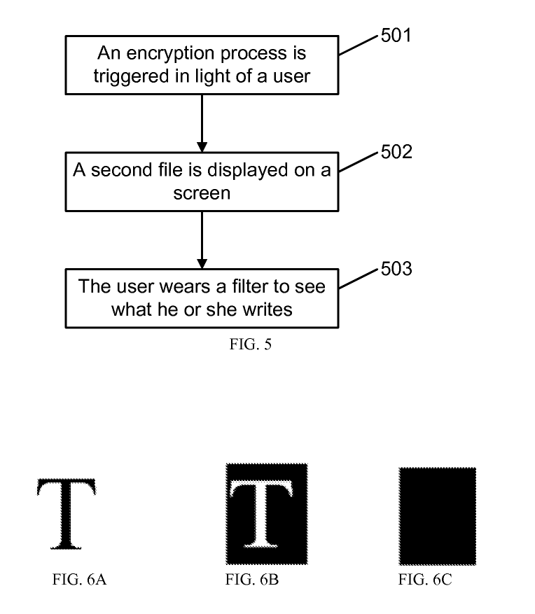

In a scenario as shown in FIG. 5, when a user intends to type something shown on the screen of the electronic device, an encryption process can be triggered in light of the user's requirements to change what the user types into a second file with A-B type frames (block 501). Then, the second file is displayed on the screen (block 502). The user can wear a filter to see what he or she writes while others can see nothing (block 503).

FIGS. 6A-6C illustrates a character secure solution according to an example of the present disclosure. For example, when capital letter T is input, an original frame for capital letter T is a black text on a white background as shown in FIG. 6A. During an encryption process, a compensated frame for capital letter T is generated by reversing the color of the original frame. The compensated frame is a white text on a black background as shown in FIG. 6B. The user with the filter can see the original frame as shown in FIG. 6A. For example, wearing a pair of glasses that can filter frames with type B will enable the real character to be presented. However, other users without the filter can see nothing but a black block as shown in FIG. 6C. Therefore, other users can not acquire private information from the screen of the electronic device.

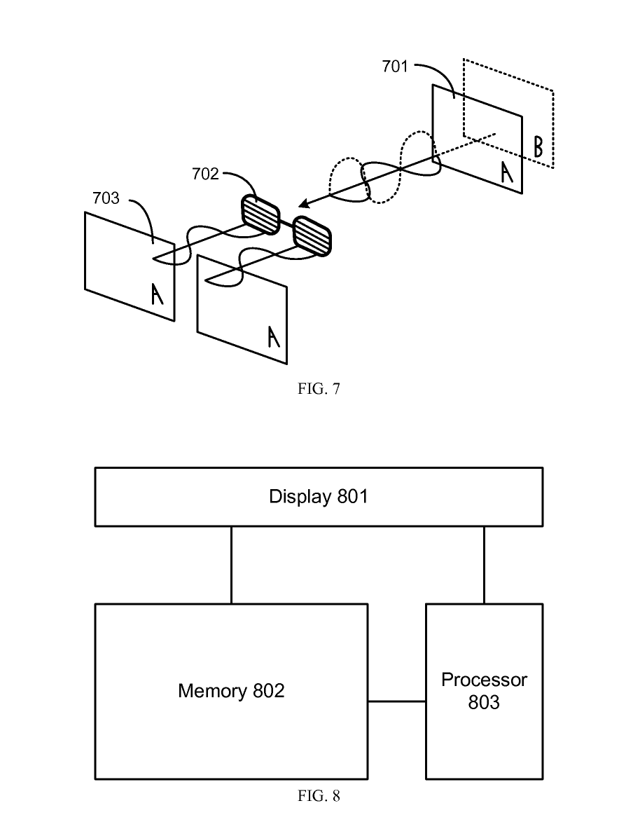

FIG. 7 illustrates transmission of light waves passing through polarization glasses. In FIG. 7, frames with type A emitted from a screen 701 have a horizontal polarization direction shown in solid line, while frames with type B emitted from the screen 701 have a vertical polarization direction shown in dotted line. Then, both lenses of the polarization glasses 702 allow light waves with horizontal vibration direction to pass through, and light waves with other vibration directions including the vertical polarization direction are blocked. By using the structure, both of a user's eyeballs will now receive light waves that have been oriented in the horizontal direction. In this way, the frames with type A are received by the user's two eyes 703, and the frames with type B will not arrive at the user's eyeballs. Specifically, each frame has been polarized using a filter on the screen 701, and this filter orients each frame's waves of light in a specific direction, i.e., frames with type A in a horizontal polarized direction and frames with type B in a vertical polarized direction. A user wears a pair of glasses 702 as if he or she were attempting to view a three-dimensional image on the screen. When the user straps on polarized glasses, he or she sees images displayed on the screen 701 having the same polarized direction with that of the polarized glasses 702.

In another example, a picture secure solution is provided. When a game player uses an electronic device to play games and he or she does not want other person to see an original picture (indicated as picture A) of the game, a compensated picture (indicated as picture B) having reversed colors of the original picture can be created. For example, when a portion of the original picture is yellow, the corresponding portion of the compensated picture is blue. Thus, the player wearing special glasses can filter frames with type B then see the real picture. Other person without the special glasses can see gray blocks filling the entire screen. In other words, the player gets picture A and cannot see picture B, while other person can see an overlap of picture A and picture B which is an all-gray picture without any useful information.

By using second information with a data format including original part and compensated part and a pair of specs compatible to the data format, the technology for securing the display of information on a screen can get different perspectives with or without the specs, thereby securing the privacy in public in a wide range of application scenarios. For example, when a person uses a laptop PC while sits on the train in a situation where one does not want the display screen to be visible to one's neighbors, the anti-peeking display technology provided in the present disclosure can be employed. For another example, when a customer enters his or her personal identification number (PIN) on an ATM terminal, he or she may initiate an anti-peeking display mode provided in the present disclosure, and the anti-peeking display mode can be closed to display advertising normally when the ATM is not in use.

In an example of the present disclosure, an electronic device for presenting visible information to a user is provided. The electronic device shown in FIG. 8 includes a display 801 to present information in visual form to the user, a memory 802 to store instructions and the information for display, and a processor 803.

Specifically, the display 801 is a device for presentation of information in visual form, wherein the information is supplied as an electrical signal. The display 501 may be a two dimensional (2D) display, or a three dimensional (3D) display. In an example, the display can be a 3D LCD TV, or a touch screen of a smart phone.

The memory 802 is coupled to the processor 803 and stores machine readable instructions executable by the processor 803 to perform the operations described in such as block 101 and 102 shown in FIG. 1. For example, a set of instructions is to obtain second information corresponding to first information, wherein the first information has a plurality of original frames, and the second information has a plurality of pairs of frames each pair comprising an original frame included in the first information and a corresponding compensated frame, and to provide the second information to the display 801.

The memory 802 may include high speed random access memory and may also include non-volatile memory, such as one or more magnetic disk storage devices, flash memory devices, or other non-volatile solid state memory devices.

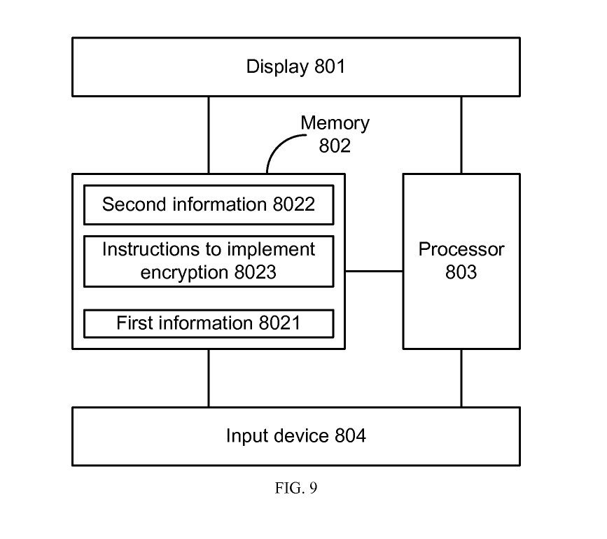

FIG. 9 is a block diagram illustrating an electronic device according to an example of the present disclosure. In the example, the memory 802 may include first information 8021 readable by a user with naked eyes. The memory 802 further includes instructions to implement encryption 8023 to: reverse the color of an original frame included in the first information 8021 to generate the corresponding compensated frame, and insert the compensated frame to a position adjacent in time sequence to the corresponding original frame to form second information 8022. The second information 8022 is also stored in the memory 802.

In an example, the electronic device has a touch sensitive screen, and a button is set on the screen. When a user presses the button before processing the first information such as opening a file or typing a letter or entering a password, a signal is sent to the processor 803. Then, the processor 803 invokes the instructions to implement encryption 8023 stored in the memory 802 to change the first information into second information with A-B type frames 8022, and provides the second information 8022 to the display 801 for presentation. In another example, the electronic device has an ordinary monitor, and a button can be set on an input device 804 (such as a keyboard of the electronic device). When a user presses the button, the processor 803 is triggered to perform corresponding changes for information. In this way, switch from a shared-viewing mode to a veiled-screen mode is provided with the simple press-of-a-button. The working procedure of the electronic device shown in FIG. 9 may refer to FIGS. 4-5.

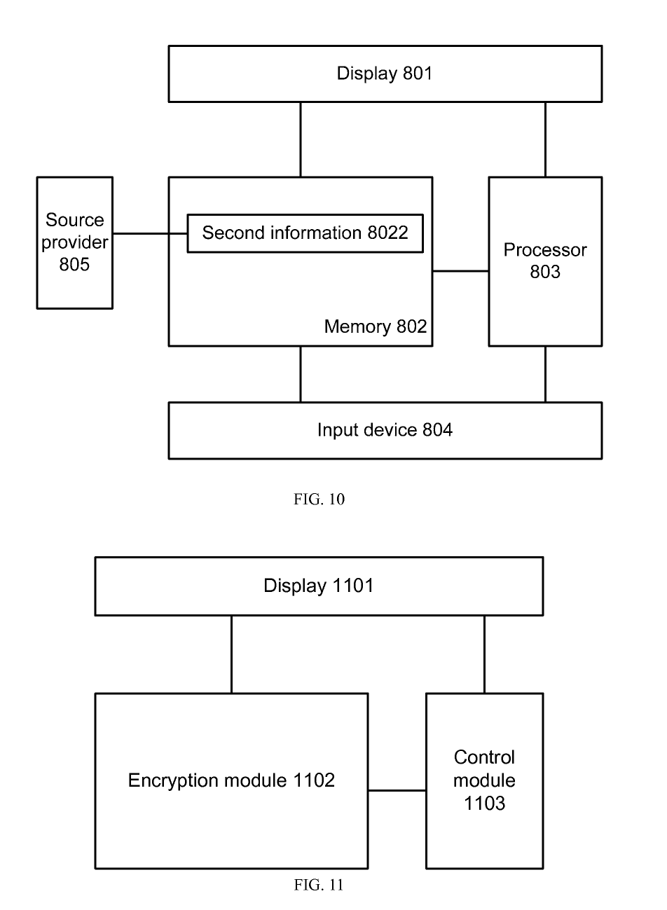

FIG. 10 is a block diagram illustrating an electronic device according to an example of the present disclosure. In the example, the memory 802 may prestore second information 8022 with the special data format, wherein the second information 8022 is provided by a source provider 805. A user selects the second information 8022 through an input device 804 (such as a mouse), and the second information 8022 is displayed in the display 801. The working procedure of the electronic device shown in FIG. 10 may refer to FIG. 3.

FIG. 11 is a block diagram illustrating an electronic device according to an example of the present disclosure. The electronic device includes a display 1101, an encryption module 1102 and a control module 1103. Specifically, the encryption module 1102 reverses the color of each original frame included in first information to generate a corresponding compensated frame, and inserts the compensated frame to a position in the first information adjacent in time sequence to the corresponding original frame to form second information. Then, the control module 1103 provides the second information to the display 1101. In an example, the encryption module 1102 changes a first data stream 8021 input by a user via an input device 804 or prestored in the memory 802 into a second data stream 8022 with A-B type frames. Specifically, the encryption module 1102 can be implemented by the processer 803 via executing a series of instructions 8023 stored in the memory 802 beforehand.

In an example, the control module 1103 sets a first polarization direction for light displaying the original frames on the display 1101, and sets a second polarization direction for light displaying the compensated frames on the display 1101, wherein the first polarization direction is orthogonal to the second polarization direction. In another example, the control module 1103 sets a first wavelength for light displaying the original frames on the display 1101, and sets a second wavelength for light displaying the compensated frames on the display 1101, wherein the first wavelength is selected from the wavelength of red light, the wavelength of green light, and the wavelength of blue light, and the second wavelength different from the first wavelength is also selected from the wavelengths of red light, green light, and blue light. In another example, the control module 1103 controls the refresh frequency of the display 1101 for sequentially display the frames of the second information.

FIGS. 8-11 are examples of an electronic device, and the electronic device may have more or fewer components than shown, or a different configuration of components. For example, the electronic device may further include components such as a peripherals interface, a bus, communications circuitry, power supply, and an input/output (I/O) subsystem. The various components of the electronic device may be implemented in hardware, software or a combination of both hardware and software, including one or more signal processing and/or application specific integrated circuits.

In an example, a filter cooperated with the electronic device is also provided. The filter restricts the light that reaches the user's eyes. Specifically, the filter is to block the compensated frames included in the second information to avoid retentivity of vision. For example, the filter may be a pair of glasses including two lenses. For another example, the filter is contact lenses. Specifically, the filter is shutter glasses, or polarization glasses, or wavelength multiplexed glasses.

As for shutter glasses, the two lenses of the glasses are normally made of liquid crystal. The first lens and the second lens are, simultaneously, open when a frame with type A is provided in the display, and close when a frame with type B is provided in the display. In this way, original frames are seen by the authorized user while compensated frames are filtered. Hence, the user is able to see his or her right point-of-view in 2D.

In an example, the shutter glasses may further include a synchronization module to receive a synchronization signal transmitted from a wired line connecting the shutter glasses with the electronic device, or to receive such as an infrared synchronization signal from an emitter of the electronic device. The two lenses are open or shut according to the synchronization signal. Further, the shutter glasses may include a power supply to drive open and close of the two lenses.

As for polarization glasses (also called polarized glasses), the two lenses of the glasses are polarizers having the same polarized direction. The polarizers can be such as linear polarizers or circular polarizers. The polarized glasses allow light waves to enter if they're oriented in the same direction as each lens's polarized filter. If the two lenses are placed horizontally, horizontal waves are transmitted to eyeballs of a user. That is, the filter passes only that light which is similarly polarized as the polarizing filter on the lenses and blocks the light polarized in the opposite direction. Viewers without the polarized glasses will receive both horizontal waves and vertical waves. Their brains go to process the two reversed images coming in nearly the same time, and they are fooled to see meaningless blocks due to retentivity of vision. Compared with shutter glasses, polarization glasses are light-weight and battery-free.

It is known that the wavelength of red light is 620-750 nm, the wavelength of green light is 495-570 nm, and the wavelength of blue light is 450-495 nm. In an example, frames with type A are modulated on a first wavelength selected from the three wavelengths, while frames with type B are modulated on a second wavelength selected from the three wavelengths which is different from the first wavelength. As for wavelength multiplexed glasses, the two lenses of the glasses are designed to filter light waves with the second wavelength and remain light waves with the first wavelength. Hence, those with the right glasses can see original information including the frames with type A, while other person can not reveal the original information from the obfuscated content including both the frames with type A and the frames with type B.

In an example, a system for securing the display of information includes an electronic device and a filter as described in the above-mentioned examples shown in such as FIGS. 1-11. Generally, the filter works by openly presenting the original frames intended for the first information while blocking the compensated frames.

The foregoing description, for purpose of explanation, has been described with reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications as are suited to the particular use contemplated.

The above examples may be implemented by hardware, software, firmware, or a combination thereof. For example the various methods, processes and functional modules described herein may be implemented by a processor (the term processor is to be interpreted broadly to include a CPU, processing unit/module, ASIC, logic module, or programmable gate array, etc.). The processes, methods and functional modules may all be performed by a single processor or split between several processors; reference in this disclosure or the claims to a ‘processor’ should thus be interpreted to mean ‘one or more processors’. The processes, methods and functional modules are implemented as machine readable instructions executable by one or more processors, hardware logic circuitry of the one or more processors or a combination thereof. The modules in the aforesaid examples may be combined into one module or further divided into a plurality of sub-modules. Further, the examples disclosed herein may be implemented in the form of a software product. The computer software product is stored in a non-transitory storage medium and comprises a plurality of instructions for making an electronic device implement the method recited in the examples of the present disclosure.

What is claimed is:

1. A method for securing the display of information provided by an electronic device, comprising:
obtaining second information corresponding to first information, wherein the first information has a plurality of original frames, and the second information has a plurality of pairs of frames each pair comprising an original frame included in the first information and a corresponding compensated frame;
displaying the second information on a screen of the electronic device; and
removing the compensated frames by use of a filter associated with the electronic device.

2. The method according to claim 1, wherein obtaining the second information comprises:
reversing the color of an original frame included in the first information to generate the corresponding compensated frame; and
inserting the compensated frame to a position adjacent in time sequence to the corresponding original frame.

3. The method according to claim 2, wherein reversing the color of the original frame comprises:
reversing original color of a first portion of the original frame; and
recording the first portion of the original frame with reversed color and the other portion of the original frame with the original color to form the corresponding compensated frame.

4. The method according to claim 1, wherein obtaining the second information comprises:
obtaining the second information prestored in a memory of the electronic device.

5. The method according to claim 1, wherein displaying the second information comprises:
setting first optical characteristics when displaying the original frames on the screen; and
setting second optical characteristics when displaying the compensated frames on the screen;
wherein the first optical characteristics and the second optical characteristics are different.

6. The method according to claim 5, wherein displaying the second information comprises:
setting a first polarization direction for light displaying the original frames on the screen; and
setting a second polarization direction for light displaying the compensated frames on the screen;
wherein the first polarization direction is orthogonal to the second polarization direction.

7. The method according to claim 6, wherein removing the compensated frames comprises:
setting the filter to block the light with the second polarization direction.

8. The method according to claim 5, wherein displaying the second information comprises:
setting a first wavelength for light displaying the original frames on the screen; and
setting a second wavelength for light displaying the compensated frames on the screen;
wherein the first wavelength is selected from the wavelength of red light, the wavelength of green light, and the wavelength of blue light, and the second wavelength different from the first wavelength is also selected from the wavelengths of red light, green light, and blue light.

9. The method according to claim 8, wherein removing the compensated frames comprises:
setting the filter to block the light with the second wavelength.

10. The method according to claim 1, wherein displaying the second information comprises:
sequentially displaying the frames of the second information on the screen according to a refresh frequency.

11. The method according to claim 10, wherein removing the compensated frames comprises:
setting the filter to close at the time the compensated frames are displayed on the screen according to the refresh frequency.

12. The method according to claim 1, wherein each original frame is a positive image, and the corresponding compensated frame is a negative image.

13. An electronic device, comprising: a display; a memory; and a processor, wherein the memory is coupled to the processor and stores machine readable instructions executable by the processor to:
obtain second information corresponding to first information, wherein the first information has a plurality of original frames, and the second information has a plurality of pairs of frames each pair comprising an original frame included in the first information and a corresponding compensated frame;
provide the second information to the display; and
the display is to present the second information in visual form.

14. The electronic device according to claim 13, wherein the memory further stores machine readable instructions executable by the processor to:
set a first polarization direction for light displaying the original frames on the display; and
set a second polarization direction for light displaying the compensated frames on the display;
wherein the first polarization direction is orthogonal to the second polarization direction.

15. The electronic device according to claim 13, wherein the memory further stores machine readable instructions executable by the processor to:
set a first wavelength for light displaying the original frames on the display; and
set a second wavelength for light displaying the compensated frames on the display;
wherein the first wavelength is selected from the wavelength of red light, the wavelength of green light, and the wavelength of blue light, and the second wavelength different from the first wavelength is also selected from the wavelengths of red light, green light, and blue light.

16. The electronic device according to claim 13, wherein the memory further stores machine readable instructions executable by the processor to:
sequentially display the frames of the second information on the display according to a refresh frequency.

17. An electronic device, comprising:
a display;
an encryption module, to reverse the color of each original frame included in first information to generate a corresponding compensated frame, and insert the compensated frame to a position in the first information adjacent in time sequence to the corresponding original frame to form second information; and
a control module, to provide the second information to the display.

18. The electronic device according to claim 13, further comprising a filter to block the compensated frames included in the second information.

19. The electronic device according to claim 18, wherein the filter comprises shutter glasses, polarization glasses, or wavelength multiplexed glasses.

20. The electronic device according to claim 18, wherein a secure display system comprises the electronic device and the filter.
